(19) United States
(12) Patent Application Publication
(10) Pub. No.: US 2005/0088404 A1
(43) Pub. Date: Apr. 28, 2005

(54) Display devices

(76) Inventors: Amichai Heines, Herzelia (IL); Adiel Karty, Zichron-Yaakov (IL); Allon Cohen, Modyin (IL)

Correspondence Address: FENSTER & COMPANY INTELLECTUAL PROPERTY 2002 LTD.;C/O REED SMITH LLP, 599 LEXINGTON AVENUE, 29TH FLOOR, NEW YORK, NY, 10022-7650, US

(21) Appl. No.: 10/497,471

(22) PCT Filed: Dec. 3, 2002
(86) PCT No.: PCT/IL02/00970

Related U.S. Application Data
(60) Provisional application No. 60/334,589, filed on Dec. 3, 2001.
(60) Provisional application No. 60/361,321, filed on Mar. 4, 2002.

(51) Int. Cl. G09G 3/34

(52) U.S. Cl. 345/108

(57) ABSTRACT

Apparatus including: a substrate, having a substrate surface, at least a portion of which is transparent or apertured; and an array of objects each having a maximum dimension smaller than 1 mm attached to the substrate and having an axis about which the object can rotate, wherein the object has two stable positions, a first stable position at which the object covers a transparent or apertured portion of the substrate and a second stable position at which the transparent portion is at least partially uncovered.

### RELATED APPLICATIONS

This application claims the benefit of U.S. Provisional Application 60/334,589 filed Dec. 3, 2001 and of U.S. Provisional application 60/361,321, filed Mar. 4, 2002. The present application is related generally to PCT application serial number PCT/IL99/00488, filed Sep. 8, 1999 and published as WO 00/52674, PCT/IL99/00130, filed Mar. 4, 1999 and published as WO 99/45423, PCT application PCT/IL00/00475, filed Aug. 6, 2000 and published as WO 02/13168, and PCT application PCT/01/01076, filed Nov. 22, 2001 and published as WO 02/42826, the disclosures of all of which are incorporated herein by reference.

Some of the subject matter of these applications is related to a best mode of carrying out the invention. This should not be construed as limiting the invention to embodiments which utilize all or even some of this matter.

### FIELD OF THE INVENTION

The invention relates to the field of micro-machined and micro-formed devices with particular applicability to displays produced by micro-machining and other applications of micro-machined shutters and shutter arrays.

### BACKGROUND OF THE INVENTION

Some micro-display devices create an image that is optically projected for display. Current micro-display devices use transparent LCD devices, reflective LCD (LCOS) devices or reflective Micro Mirror Devices. Each has limitations of cost and performance, especially with regards to light intensity on screen and to contrast between the bright and dark state. Micro-display devices are also used in applications other than imaging for Spatial Light modulation. A constant demand exists for more efficient micro-display devices with lower manufacturing costs.

In response to the demand, new types of micro-display devices have been developed, based on MEMS technology. MEMS technology enables microstructures having features on the order of a few microns to be formed on appropriate silicon or other substrates. The technology can therefore be used to produce pixel array devices, on silicon that can manipulate light. Arrays of these devices are useable to form micro-display devices that provide high-quality images.

Most micro-display devices currently produced using MEMS technology are reflective devices with either
A. micro-mirrors that reflect the light in slightly different angles according to the position to which the micro-mirror is switched; or,
B. Reflective ribbons that control light reflection by creating diffraction gratings.

The reflective nature of both these technologies impose projection optics which are cumbersome and expensive in relation to transmissive projection optics. Collection losses are also created in such devices due to an inherent mismatch of the collection optics endue and the endue of the micro-display devices. In addition, in many of these devices, the beam impinges at an angle to the array, causing distortion of the image.

### SUMMARY OF THE INVENTION

An aspect of some embodiments of the present invention is concerned with electromechanical displays having very small display elements.

In an embodiment of the invention, the display comprises pixels, each of which includes a panel that is mechanically flipped so that it is either in a CLOSED position, parallel to a surface on which it is formed or in an OPEN position, close to a vertical orientation with respect to the surface. In an embodiment of the invention, the panel rotates about an axis on which an optionally rounded (but not necessarily round) axle is formed. In an exemplary embodiment of the invention, the axle is a horizontal axis. Optionally, the panel flips from one position (the CLOSED position) at which it is substantially parallel to (or at a relatively small acute angle to) a viewing face of the display to another position (the OPEN position) in which it is substantially perpendicular to (or at a relatively large obtuse angle to) the viewing face. The area under the panel when it is substantially parallel to the substrate is transparent, such that the panel acts as a light valve.

As used herein, the term “rounded” means a cylinder or edge which has a generally rounded shape. The term includes a generally circular shape. It also includes a generally elliptical shape and all or a portion of a hexagon, pentagon or octagon or shape having a greater number of sides. It also includes a shape that is in the form of stepped layers having a generally round outline.

As used herein, the term substantially perpendicular to means at an angle that is 90 degrees +/−10 degrees and substantially parallel to means at an angle of less than 15 degrees to the substrate surface.

In an embodiment of the invention, the panel is formed with an axle along an axis about which it turns. The axle may be rounded, but may also be square. The axis is substantially horizontal to the substrate surface. Optionally, the axle rolls along at least one rolling surface that is substantially parallel to the substrate surface. In an exemplary embodiment of the invention, the object, the axes and the rolling surface are produced by MEMS technology.

An aspect of some embodiments of the invention is concerned with a method of flipping a panel in a micro-mechanical display. In an embodiment of the invention, a panel, optionally coated, is constrained to have two stable positions. The panel is formed with an axle around which it generally rotates (although some sideways movement may also be present). The axle is spaced from the edge of the panel, leaving an electrically conducting “tail” on the other side of the axis from a main portion of the panel. In order to flip the panel a voltage is applied to an electrode under the tail, which attracts the tail and by leverage, starts the flipping action, by rotating the panel about the axle. As the panel reaches a vertical position (i.e., it is perpendicular to the surface on which it is mounted), the voltage is shut off and the panel hits a surface which acts as a mechanical stop.

Optionally, a levitation electrode is provided above the surface, outboard of the edge of the panel at the stable position parallel to the surface. The levitation electrode has the function, when flipping from the CLOSED to the OPEN position (hereinafter opening), of one or both of (1) raising the panel from a base on which it rests to negate stiction prior to the flipping and (2) inhibiting the flipping action. These functions are achieved by providing a voltage at the levitation electrodes which attracts the panel and lifts it, at the same time inhibiting the rotation of the panel by the flipping electrode. When the levitation electrode voltage is turned off, the flipping electrode flips the panel. Optionally, the levitation electrode is electrified when flipping, from the OPEN to the CLOSED position (hereinafter closing) to aid in bringing the panel from the perpendicular to the parallel position.

There is thus provided, in accordance with an embodiment of the invention, apparatus comprising:
a substrate, having a substrate surface, at least a portion of which is transparent or apertured; and
an array of objects each having a maximum dimension smaller than 1 mm attached to the substrate and having an axis about which the object can rotate,
wherein the object has two stable positions, a first stable position at which the object covers a transparent or apertured portion of the substrate and a second stable position at which the transparent portion is at least partially uncovered.

In an embodiment of the invention, the substrate is transparent over at least a portion of the area covered by the object in the first stable position and uncovered by the object in the second stable position. Optionally, the substrate is made of a transparent material. Optionally, the area of the substrate that is not covered by the object in the first stable position is covered with a substantially opaque material.

In accordance with an embodiment of the invention, the substrate is made of an opaque material and at least a portion of the region covered in the first stable position is formed with apertures.

Optionally, the maximum extent of the object is less than 200 micrometers, under 90 micrometers, under 50 micrometers, under 20 micrometers or about 10 micrometers.

In an embodiment of the invention, the object comprises an object body, optionally a panel, which covers the transparent area in the first stable position. Optionally, the panel is substantially parallel to the surface of the substrate in the first stable position and is substantially perpendicular to the substrate in the second stable position.

Optionally, the object body is substantially opaque to at least a band of wavelengths. Optionally, the band of wavelengths includes the visible band.

In an embodiment of the invention, the objects comprise:
an axle, attached to the object body;
an axle support attached to the substrate and having a support surface, wherein:
the axle has a rounded cross-section, as manufactured;
the axle forms a non-zero angle with a perpendicular to the surface; and
the axle is capable of rotation, such that the object rotates about the axis.

Optionally, the axle is along said rotation axis. Optionally, the axle is at an angle to the axis.

Optionally, the axle rolls along the axle support surface as the object rotates. Optionally, the apparatus includes at least one socket within which the axle rotates. Optionally, the socket overlays the axle support surface and wherein the axle is constrained between the support surface, edge constraints and a top constraint. Optionally, the distance between the side constraints is larger than a diameter of the axle, and the axle is not constrained by the socket between the side support surfaces.

Optionally, the axle is comprised in two axially separated parts and the object is attached to the axle between the two parts. Optionally, the object extends on both sides of the axle. Optionally, the axle support surface is generally parallel to the substrate surface. Optionally, the axis of the axle is substantially parallel to the substrate surface. Optionally, the object has a planar surface that is parallel to the axle. Optionally the planar object extends to a first extent on one side of the axis and extends to a lesser extent on a second side.

Optionally, the planar object is electrically conducting over at least a portion of its extent. Optionally, the planar object is conducting over at least a portion of the lesser extent.

There is further provided, in accordance with an embodiment of the invention, apparatus comprising:
a substrate, at least portions of which are transparent to a band of wavelengths or are apertured;
an array of panel shaped objects attached to the substrate and rotatable from a first position in which a transparent or apertured portion of the substrate is covered to a second position in which said transparent portion is uncovered;
an axle attached to the panel, which is rotatable, such that the panel rotates about an axis;
a constraint that limits the extent of the rotation to substantially 90 degrees.

Optionally the axis of rotation is an axis of the axle. Optionally, the panel comprises a first portion on one side of the axle that covers transparent portion of the substrate and a second, tail, portion on the other side of the axis. Optionally, the constraint comprises an object, protruding from the surface of the substrate, that engages the tail portion when the panel rotates to about 90 degrees.

Optionally, the constraint comprises an object, above the plane of the panel adjacent to the axle, which engages the panel when the panel rotates to about 90 degrees.

There is further provided, in accordance with an embodiment of the invention, apparatus comprising:
a substrate at least portions of which are transparent to a band of wavelengths or are apertured;
an array of panel shaped objects rotatable from a first position in which a transparent or apertured portion of the substrate is covered to a second position in which said transparent portion is uncovered;
an axle attached to the panel, which is rotatable, such that the panel rotates about an axis, wherein the panels comprise a first portion on one side of the axle that covers transparent portion of the substrate and a second, tail, portion on the other side of the axis;
a first, opening, electrode on the substrate underlying a portion of the second portion and the axis;
a second, closing, electrode on the substrate outboard of the second portion when the panel is in the first position; and
a power supply for electrifying the first and second electrodes.

Optionally, the axis of rotation is an axis of the axle.

Optionally, the apparatus includes a controller that is operative to electrify the opening electrode, when the panel is in the first position, to attract the tail thereto, thereby to flip the tail to said second position.

Optionally, the apparatus includes a constraint to limit the rotation of the panel to about 90 degrees. Optionally, the constraint comprises an object that engages the panel when it rotates about 90 degrees. Optionally, stiction between the object and the panel keeps the panel in said second position.

Optionally, the controller is operative to electrify the closing electrode, when the panel is in the second position, to attract the tail to it, causing the electrode to move from the second position to the first position.

In an embodiment of the invention, the apparatus includes a levitation electrode, situated above the level of the panel in the first position and wherein the controller selectively electrifies the levitation electrode to aid in at least one of the movements of the panel from the first position to the second position and from the second position to the first position.

In an embodiment of the invention, the apparatus includes at least one holding electrode situated near the panel in the first position, wherein electrification of at least one holding electrode inhibits movement of the panel from the first to the second positions. Optionally, the array is a rectangular array of rows and columns of panels, each panel having two holding electrodes, one of the holding electrodes being connected electrically with other such electrodes in the column of the panel and the holding electrodes being connected to other such electrodes in the row of the panel, such that each pixel can be separately allowed to change from the first to the second position by not electrifying both the column and row electrodes associated with the panel.

In an embodiment of the invention, the maximum extent of the panel is less than 1 mm, less than 200 micrometers, less than 90 micrometers, less than 50 micrometers, less than 20 micrometers or 10 micrometers.
there is further provided a projection display, comprising:
apparatus according to the invention;
a source of light that illuminates the apparatus; and
a controller that selectively positions said objects in said first and second positions to form an image in the light passing through the apparatus.

Optionally, the controller is operative to control a brightness of said light passing through a pixel corresponding to a given object by positioning said object in said second position for a time commensurate to said brightness. Optionally, the controller is position the objects in the second position at different times during a picture frame and to position all of the objects in the first position at the same time.

there is further provided, in accordance with an embodiment of the invention a multicolor display comprising:
a plurality of displays according to the invention, each illuminated by a separate light source of a different color; and
a combiner that combines the light passing through the arrays.

Optionally the display includes means for periodically changing the color of the light from the light source, such as a color wheel, so that the apparatus is successively illuminated by light of different colors.

Preferably the positioning of the objects and the means for changing the colors are synchronized.

Optionally the display includes a projection lens for projecting light passing through the apparatus onto a surface.

Optionally, the positions of the objects are periodically changed to provide a moving image.

### BRIEF DESCRIPTION OF FIGURES

Exemplary, non-limiting embodiments of the invention are described in the following description, read in with reference to the figures attached hereto. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are generally not to scale. The attached figures are:

FIG. 1A is a schematic overview of a pixel in a display, in accordance with an embodiment of the invention;

FIG. 1B is a schematic overview of the pixel of FIG. 1A, with a panel removed;

FIG. 1C shows details of an axle about which a panel in the display rotates, together with a cut away version of a socket in which the axle rotates, in accordance with an embodiment of the invention;

FIG. 1D shows a cross-section of the axle and socket, in accordance with an embodiment of the invention;

FIG. 1E shows a simplified cross-section of closing and opening electrodes and a tail of a panel, in accordance with an embodiment of the invention;

FIGS. 2A-2C illustrate the methodology of opening, in accordance with an embodiment of the invention;

FIGS. 3A and 3B illustrate the position of the panel with respect to constraints, in accordance with an embodiment of the invention;

FIGS. 4A-4C illustrate the methodology of closing, in accordance with an embodiment of the invention;

FIG. 5 shows a timing diagram of voltages for flipping, in accordance with embodiments of the invention;

FIG. 6 illustrates the results of initial process acts in the formation of the pixel, in accordance with an embodiment of the invention;

FIG. 7 schematically illustrates an alternative structure of a panel in accordance with an embodiment of the invention;

FIG. 8 illustrates an alternative method of producing a stopping nub, in accordance with an embodiment of the invention;

FIGS. 9A and 9B show alternative panel structures, which obviate the provision of a nub and results in a larger effective open area, in accordance with an embodiment of the invention;

FIG. 10 shows a layout of address and locking lines, in accordance with an embodiment of the invention;

FIG. 11 shows a layout of levitation and ground lines, in accordance with air embodiment of the invention; and

FIGS. 12 and 13 schematically illustrate two transmission type projection systems, utilizing micro-displays of the invention.

### DESCRIPTION OF EXEMPLARY EMBODIMENTS

General Structure of the Panels

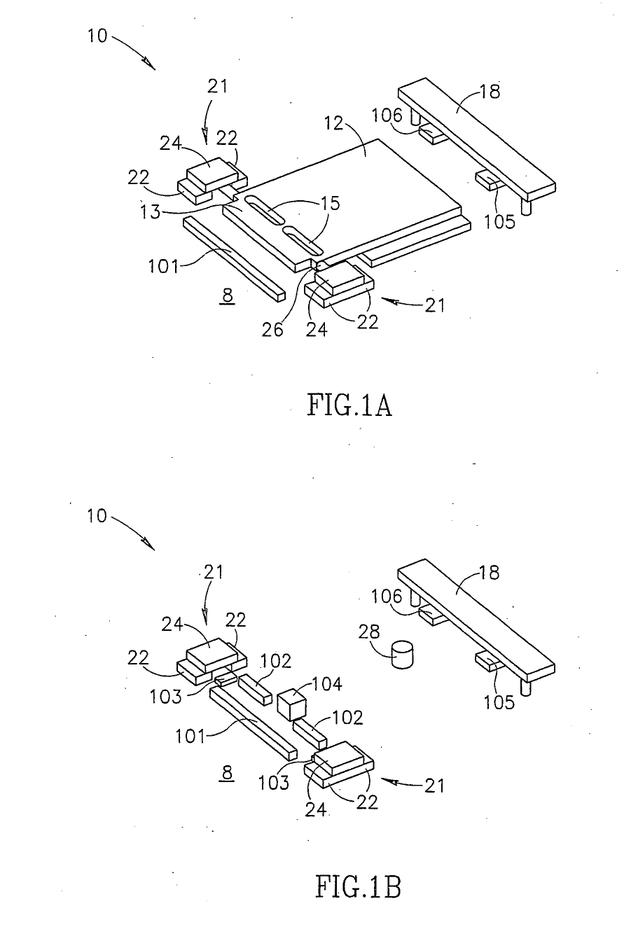

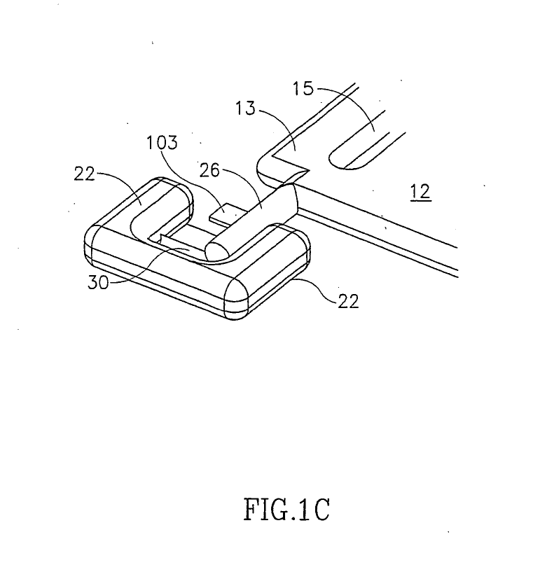

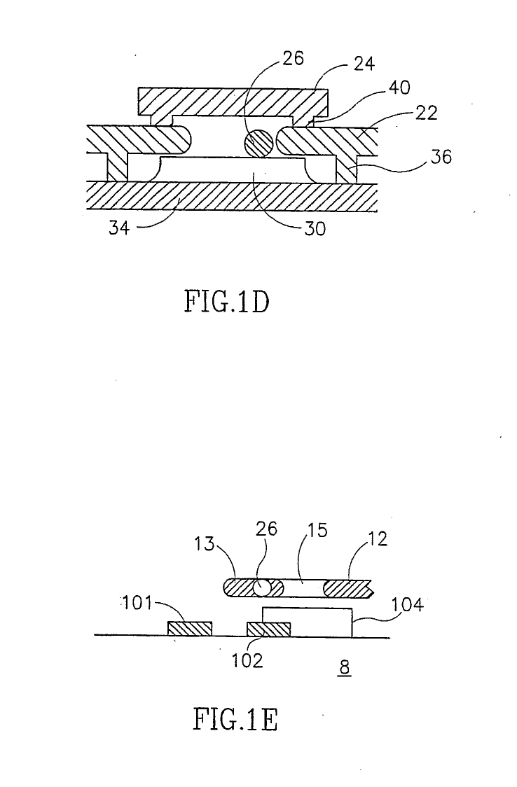

FIGS. 1A-1D show an overview of an exemplary pixel 10, in accordance with an embodiment of the invention. While this construction is presented as an example, many of the elements shown can have a different construction and some may be deleted altogether.

Pixel 10 comprises as its major components a flipping panel 12, closing electrode 101, opening electrode 102, clutch electrodes 103, stopping nub 104, row locking electrode 105, column locking electrode 106, levitation electrode 18 and a pair of sockets 21. The panels are formed with preferably rounded axles 26, which fit into sockets 21. The sockets comprise a lower, optionally wedge shaped, element 30 (sometimes referred to herein as a “knife 30”) formed with an upper edge on which the related axle rolls, a pair of side motion constraints 22 and an upper constraint 24. Each electrode is optionally formed with an optionally insulated nub 28 which minimizes the area of contact between the panel and the underlying structure.

FIG. 1A shows an isometric view of the pixel in one position, FIG. 1B shows an isometric view, where panel 12 is removed to show the structure underneath it, FIG. 1C shows a view of a socket 21 with an upper constraint 24 removed and FIG. 1D shows a cross sectional view of socket 21, including a poly 0 layer 34 on which knife 30 sits and vias 36 and 40 that connect the parts together mechanically and electrically.

In the method of construction described below, the base structure is made essentially of interconnecting (addressing) layers Metal 1 (M1) and Metal 2 (M2), over a quartz, fused silica or glass substrate 8. For some embodiments, a transparent plastic substrate may be used. In the structure described, the column and row addresses are in metal 1 and metal 2, Addressing lines for electrodes 101 and 102 are also in the column addressing layer, with the lines placed between the column address lines. The row and column addressing lines are covered with silicon oxide and by silicon nitride. Shielding using intervening lines or layers is optionally provided.

Via holes connect the addressing lines (and voltages for electrodes 101 and 102) to the Polysilicon structure above. The Polysilicon structure, which is deposited in three layers, designated Poly 0, Poly 1 and Poly 2. In other embodiments, the structures can be metal or even plastic (metalized or made conducting by other means). For ease of visualization, the layers are indicated with a same type of diagonal cross-hatching with layers 0 and 2 having right leaning diagonal lines and layer 1 having left leaning diagonal lines. In general, all of the polysilicon is made conducting.

In an embodiment of the invention, electrodes 101, 102, 103, 105 and 106, (including nub 28, knife 30 and stopping nub 104) and the base of the side motion constraints are laid down in Poly 0. Panel 12 (including axle 26) and side motion constraints 22 are laid down in Poly 1 and levitation electrode 18 and upper constraint 24 are laid down in Poly 2. Electrification lines for the levitation electrodes and grounding for the hinges are provided in Poly 2 as well.

It should be understood that areas not covered by polysilicon material are transparent, such that when panel 12 is substantially perpendicular to the surface of substrate 8 (the OPEN position), the pixel (or rather that part under the panel in the closed position) is transparent and when the panel is substantially parallel to the surface (the CLOSED position), the pixel is not transparent. In some embodiments of the invention, one or both faces of the panel are coated with a light absorbing coating, to reduce reflections and transmission. Additionally, or alternatively, all exposed surfaces (except for those immediately below panel 12 in the CLOSED position) are coated with a light reflecting material. Optionally, the reflected light is absorbed somewhere else in the system. Absorbing material could also be used. However, the light absorbed may cause excessive heating of the micro-display.

In exemplary embodiments, the panel is 85×85 micrometers and the axle has a diameter of 2 micrometers. Alternative designs in which the panels have a 40×85 micrometer (resulting in a rectangular pixel of 40×85) or a larger size (0.2×0.2 mm is contemplated, but 1 mm×1 mm is possible) and as small as 10×10 micrometers or smaller are also within the scope of the invention. For the smaller sizes, the size of the axle may be reduced. For very large panels, it may be increased.

Opening of the Panels

In an embodiment of the invention, optional clutch electrodes 103 are energized together, pulling the axle down, ensuring good electrical contact between the axle 26 and the knife 30. Axle 26 contacts the upper edge of knife 30 (which is grounded), and is also connected to nub 28 (by a line in poly 0, not shown) so that panel 12 is grounded with them. Optional levitation electrode 18 is separately electrified (via an elevated line in poly 2, which connects all of the levitation electrodes in a column together). Opening electrode 102 is also separately electrified. It should be understood that if one or both of the addressing electrodes are positive, neither the levitation nor opening electrodes are operative to flip the panel to the OPEN position. For ease of understanding of the opening operation, FIG. 1E illustrates a cross-section of the pixel structure between the hinges along a cut perpendicular to electrodes 101 and 102. In this cross-section only opening electrode 102, closing electrode 101 and panel 12 are cut. Stopping nub 14 is shown, but not cut through.

As illustrated, panel 12 is formed with a tail end 13 that extends beyond axle 26 (shown in FIG. 1E in white, to illustrate its position). A long slot or series of slots 15 are optionally formed in panel 12, on the other side of the axle from the tail. The function of tail 13 and slots 15 will become evident in the following discussion and is described in WO 02/42826.

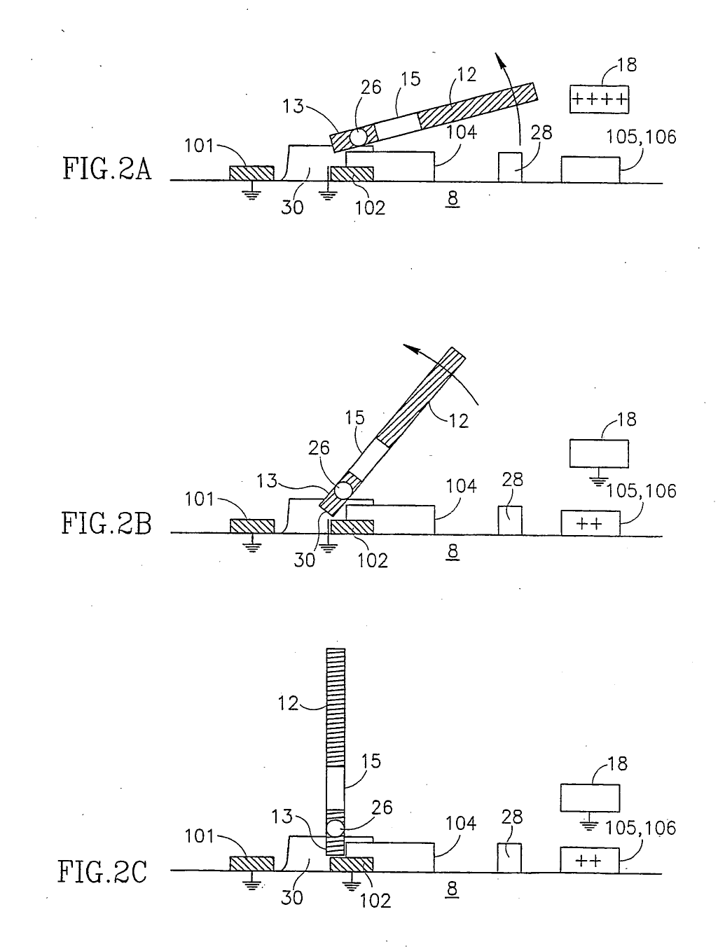

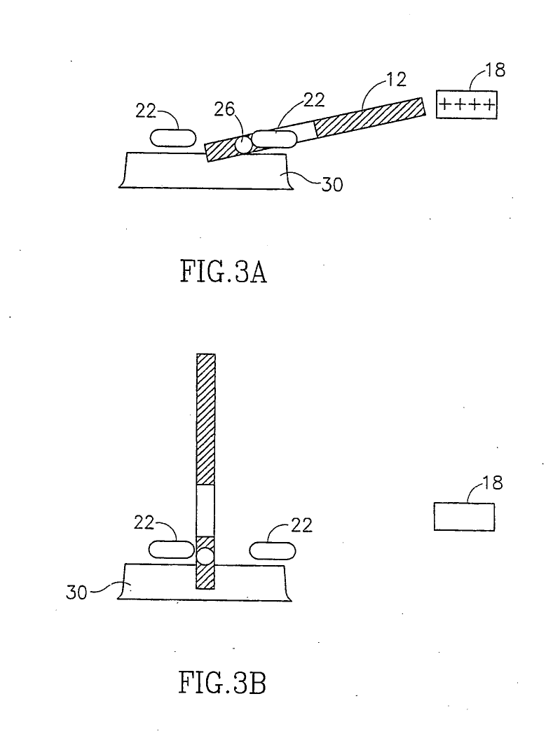

FIGS. 2A-2C illustrate a method of opening the panel. As a first act (FIG. 2A), the levitation electrode 18 is electrified. Since the levitation electrode is Poly 2, panel 12 is Poly 1 and knife 30 and nub 18 are Poly 0, the electrification of the levitation electrode will tend to lift the panel off the nub (overcoming stiction). The panel, the knife and the nub are all at the same potential (grounded in this case). Both row locking electrode 105 and column locking electrode 106 are also grounded for a selected pixel or group of selected pixels, so that there is no electrical attraction between the panel and the locking electrodes. On: the other hand, opening electrode 102 is electrified, so that tail 13 is attracted (down) in its direction. Slots 15 are cut in the panel, reducing the portion of the panel to the right of axle 26 that is substantially attracted to the opening electrode 102. A further effect of the attraction of panel 12 to electrode 18 is to position axle 26 at the right of the slot formed by knife 30 and constraining elements 22 and 24. This is illustrated in FIG. 3A. FIG. 3B illustrates the position of the axle in the OPEN position. Knife 30 is thin to reduce stiction, which can inhibit motion and rolling, or at least its initiation.

In FIG. 2B, the voltage on levitation electrode 18 has been turned off and the effect of the attraction between tail 13 and opening electrode 102 is to pull down tail 13 and provide leverage to lift the rest of panel 12, as shown. Momentum generated during this lifting operation carries the panel toward the upright (FIG. 2C) and toward stopping nub 104. Optionally, the voltage at opening electrode 102 may be reduced after the motion has started and the panel 12 continues, by inertia until the tail 13 touches the stopping Nub.

Closing of the Panels

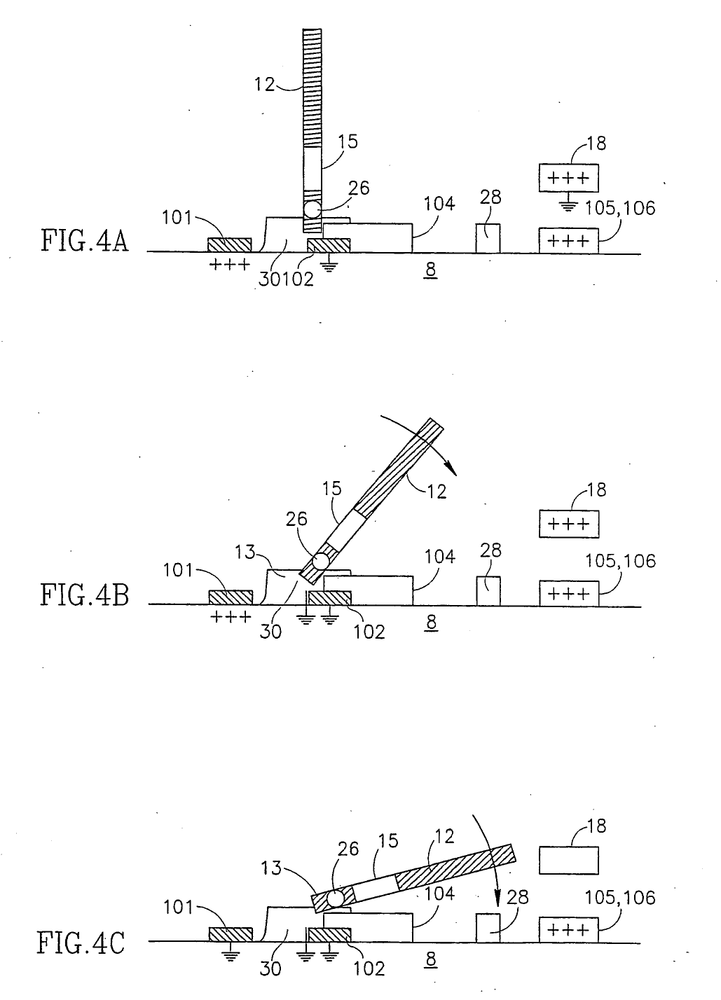

FIGS. 4A-C show the procedure for closing the panels. In order to close panel 12, closing electrode 101 is electrified for a short time, pulling the tail 13 of panel 12 which is grounded. This is enough to detach the tail 13 of panel 12 from the stopping nub 104 to which it is attached by stiction. (FIG. 4A) At the same time or a short time before or thereafter, the Levitation electrode 18 is electrified, attracting the panel 12, which continues to roll on the axle 26 towards nub 28. (FIG. 4B) As the panel nears levitation electrode 18, the voltage is removed from the levitation electrode, so that the panel can continue to fall toward nub 28. (FIG. 4C).

It should be indicated that while the voltage is indicated as being positive, the flipping works in exactly the same manner whether the voltages are positive or negative, especially if the panel is at ground potential. Furthermore, voltage levels may be different for the different electrodes (with some additional complexity in supplying the voltages) or AC voltages may be used.

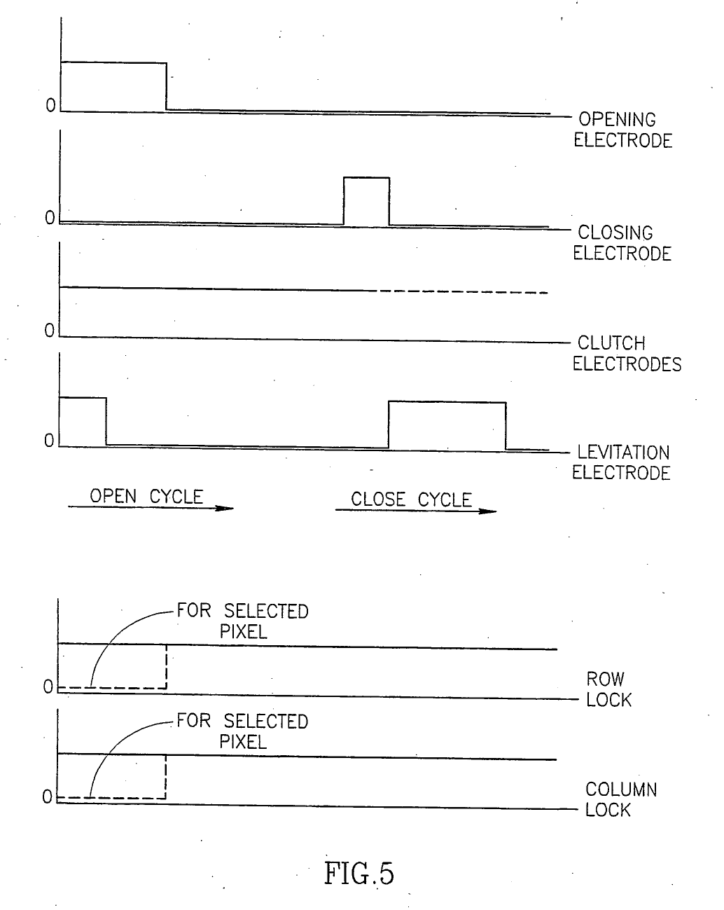

FIG. 5 illustrates a possible timing diagram for opening and closing a panel. In FIG. 5, at t₀, the system is at rest and the levitation electrode is electrified. The clutch electrodes 103 are always electrified. The opening electrode is turned on. (FIG. 2A) At t₁ the levitation electrode 18 is turned off. (FIG. 2B). At t₃, the opening electrode 102 is turned off. (FIG. 2C). The panel continues to rotate until it hits stopping nub 104. (FIG. 2C.) For the selected panel, the locking electrodes are both at zero voltage so that they do not inhibit the flipping. However, after the flipper passes the levitation electrode, they can be turned back on, since they are shielded from the panel by the levitation electrode.

Alternatively or additionally, only the tail portion and the portion at the opposite edge of the panel are made conductive (with a conductive strip connecting them both to the axles). This obviates the need for cut-outs 15.

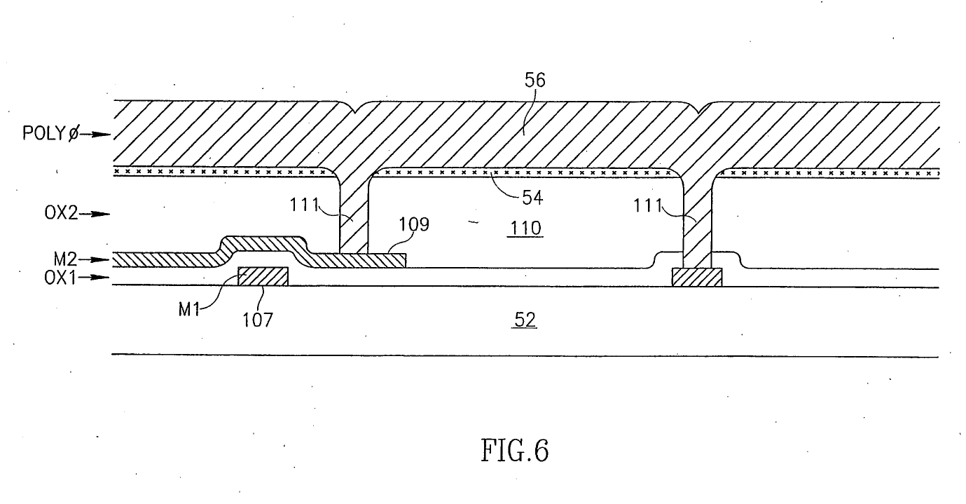

In the practice of an exemplary embodiment of the invention, the pixels are arranged in rows and columns with the addressing Lines 107 and 109 of FIG. 6 connected to row locking electrodes 105 of FIG. 1A and to column locking electrodes 106 of FIG. 1A, respectively. All levitation electrodes 18 are connected together and are thus electrified together. All closing electrodes 101 are connected together and are thus electrified together. All opening electrodes 102 are connected together and are thus electrified together, as are all clutch electrodes 103. As the opening sequence described above is executed, only those pixels for which both the row and the column locking electrodes are grounded may open. Any pixel with either locking electrode electrified will remain in its position.

Stability of Open Pixels

The locking electrodes cannot close an open pixel since their effect is shielded by the overhanging levitation electrodes. Levitation electrodes cannot close an open pixel since their effect is weak compared with the stiction forces of the stopping nub 104, due to their distance from the panel in the OPEN position.

It has been found that, for practical purposes, the stiction between panel 12 and nub 28 is often sufficient to hold the panel in place. As a further effect, the attraction of the panel to closing electrode 101 serves to position the panel on the knife in a position ready for closing.

Variations in construction and flipping methodology will be apparent to persons of skill in the art. Some methods of flipping utilize the principle described above (flipping by attracting the tail to the electrodes and utilizing the levitation electrode to control the flipping). Other methods however, such as those described in the publications in the related applications section, can be used for flipping.

It should also be noted that while a rounded axle is preferred, square axles can also be flipped using the above methodology, albeit possibly at a higher applied voltage, generally lower switching speed and potentially reduced reliability.

Fabrication of the Pixels

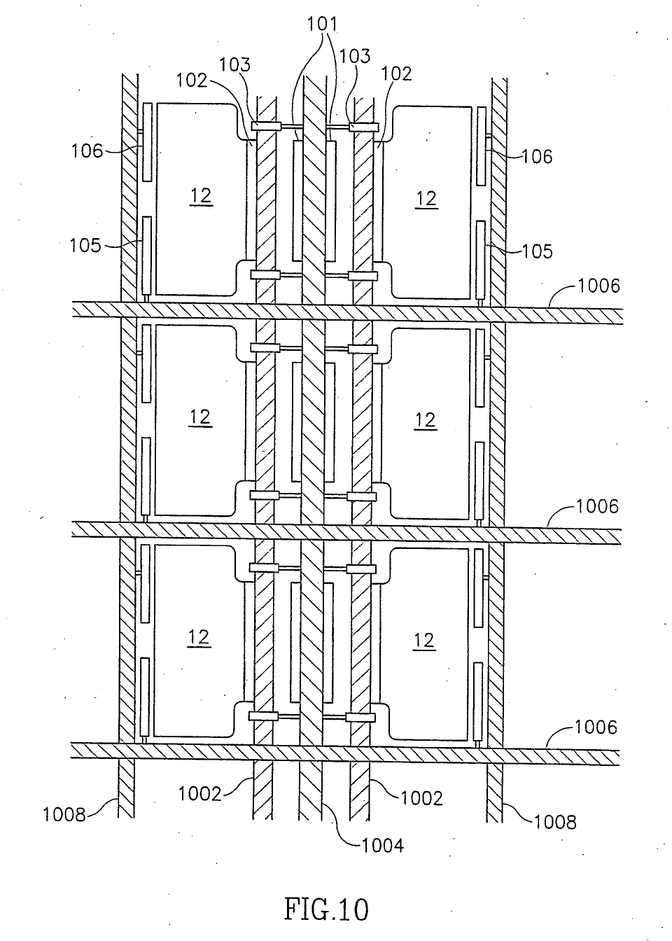

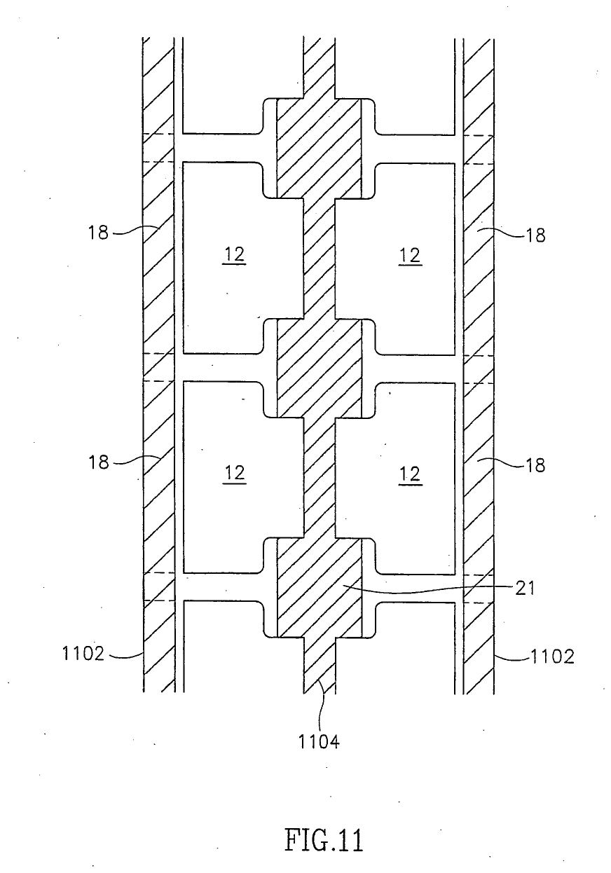

FIG. 6 illustrates the first stage of an exemplary methodology for the fabrication of a pixel as shown in FIG. 1, in accordance with an embodiment of the invention. Of course, an entire array of such pixels as partially shown in FIGS. 10 and 11, can be produced by the method on a single substrate.

The following are the acts in the process. In general, each deposition of an oxide or glass layer is followed by an anneal. It is noted that the method described is based on the process technology utilized by a particular foundry and that details may vary, even for the same process methodology. It should also be noted that for some of the oxide etches, an overlying nitride layer is used as a mask and for at least some of the polysilicon etches, the nitride and/or oxide layers are used as a mask.
A—Start substrate;
B—Deposit first metal layer;
C—Metal etch to define addressing lines;
D—Deposit Oxide
E—Deposit second metal layer;
F—Metal etch to define addressing lines;
G—Deposit Oxide and (optional) Polish;
H—Deposit Silicon nitride;
I—Etch Nitride and oxide to define vias;
J—Poly0 (Polysilicon) Deposit;
K—Poly etch to create Nubs, Knives and Stopping Nubs;
L—Poly Doping
M—Poly Etch to define electrodes;
N—Deposit Oxide;
O—Optional Polish;
P—Oxide etch to define Anchors;
Q—Poly1 (polysilicon) Deposit;
R—Phosphor silicon glass deposit and anneal;
S—Buffered oxide etch to remove glass;
T—Low temperature oxide deposit;
U—Silicon nitride deposit;
V—Poly 1 etch to form panel, side motion constraints;
W—Buffered oxide etch 500 Å;
X—Low temperature oxide deposit;
Y—Silicon Nitride deposit;
Z—Reactive ion etch of horizontal Nitride;
AA—Buffered Oxide Etch 3200 Å;
BB—Wet poly etch 800 Å;
CC—Buffered oxide etch 500 Å;
DD—Wet poly etch 800 Å;
EE—Buffered oxide etch 1000 Å;
FF—Poly Oxidation;
GG—Buffered oxide etch;
HH—Wet Nitride etch;
II—Sacrificial oxide 2 deposit;
JJ—Anneal;
KK—Chemical Mechanical polishing;
LL—Anchor 2 Etch (oxide etch) for sockets and levitation electrodes;
MM—Poly 2 (polysilicon) deposit;
NN—Phosphor silicon glass deposit and anneal;
OO—Buffered oxide etch to remove phosphor glass deposit;
PP—Poly 2 Etch to form upper axle constraint and levitation electrode;
QQ—Removal of sacrificial oxide.

Except as to the procedure for acts A-J, the process is very similar to that shown in WO 02/42826, and is not repeated here. The only major difference is the provision of address lines in poly 2 as described below.

FIG. 6 shows the substrate after process A-J. The substrate is indicated as 52 (A). Metal 1 (M1) layer (possibly TiW or another heat resistant metal or a metal silicide), is indicated as 107. It is typically 0.25 microns thick. (B) This layer is etched to form a first set of addressing lines. (C) The second metal layer (M2), (possibly TiW or another heat resistant metal), is indicated as 109. It is typically 0.25 microns thick. (E) Between the two metal layers there is an insulating oxide layer, indicated as 108 (D). It is typically 0.25 microns thick. M2 is then etched to form a second set of addressing lines. (F) Typically one set of lines is a column address line and the second is a row address line. The second metal is covered by an (optionally polished) oxide layer, typically 1 micrometer thick. (G) An acid protection and insulating silicon nitride layer (H) is indicated as 54. It is typically 0.6 micrometers thick. Heat resistant conductors are used since the laying down, doping and annealing of the polysilicon are high temperature processes.

Vias 111 are formed in the oxide layers (I) to bring the metal layers in contact with selected elements that are formed above nitride layer 54. Preferably, ion or plasma etching is used. A Poly 0 deposit (i), typically 2 micrometers, indicated by reference 56 is then laid down. The poly 0 material fills the vias and selectively attaches the metal layers to the poly 0 layer.

The Poly 0 deposit is then etched to form the nubs 18, knives 30, stopping nubs 104 and electrodes 101, 102, 103, 105 and 106. (Ks) The poly 0 layer it is made conductive by process L. Details of this etching operation are found in the above referenced WO 02/42826.

Optionally, the axles are rounded as described in the disclosure relating to FIGS. 5A-8D of WO 02/42826. The reader is referred to that publication for details, which are not repeated here.

It will be clear that the pixel can be made of materials other than polysilicon. In particular, instead of the poly layers, metal layers can be deposited and appropriate polymer sacrificial layers and etchants used. Since all of the processes involved can then be at relatively low temperatures, non-refractory metals or metals that plate at low temperatures can be used. This allows for both the addressing metal layers and the panels, electrodes, etc. to be of Cu, Ni, Co, Cr, Al or suitable alloys or other suitable metals. Furthermore, since oxides are not required for sacrificial layers, the use of hydrofluoric acid is obviated, which avoids any danger of damage to the quartz or glass substrate. Finally, appropriate plastic materials can be used in the process, optionally together with metal and/or polysilicon materials.

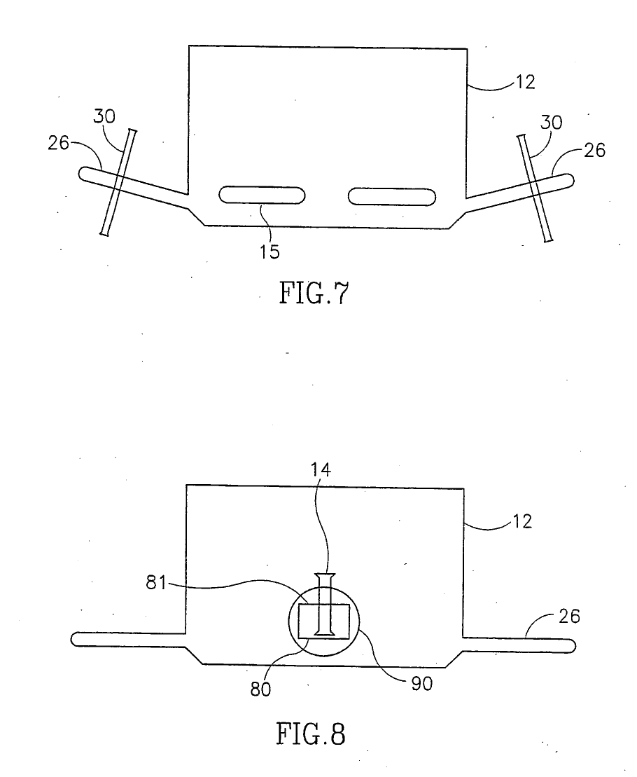

FIG. 7 shows an alternative configuration for axles 26 and knifes 30. As shown, the axes are not perpendicular to the centerline of the panel. The angle of the axles with the axis of rotation is exaggerated for clarity and would generally be between −10 and +10 degrees from the normal shown in FIG. 1. This configuration minimizes the contact area between the axles and the knives in the open position, such that even if the axles are not round and the knives are not sharp, the contact between the two is reduced to a point.

It is noted that although in FIG. 7 the knife appears as perpendicular to the axle it may be as much as 20 degrees or more out of perpendicular.

As an alternative to stopping nub 104, a bridge at poly 2 may be formed between the tops of sockets 21. This bridge will prevent the panel from passing the vertical. If such a bridge is provided, stopper nub 104 may be omitted.

FIG. 8 shows an alternative methodology of forming stopping nub 104. As indicated above, stopping nub 14 is formed in Poly 0 and the flipper panel is formed in Poly 1. Thus, misalignment between the two layers will manifest itself in the stopping edge being closer to or farther from the axis. However, the position of the stopping nub is fairly critical, since if it is too close to the axle the flipper will only open to a smaller angle and if it is too far from the axle, the tail of the panel will not hit the stopping nub.

In the illustrated construction, the flipper (poly 1) is etched with a hole 80 to expose the oxide below. A window 90 is formed in photo-resist material. Oxide and poly etch steps follow, resulting in a precisely cut stopping nub at edge 81 which forms the final stopping surface of stopping nub 104. This methodology results in a precise positioning of the stopping electrode with respect to the flipper panel and a flat, precise edge for the stopping.

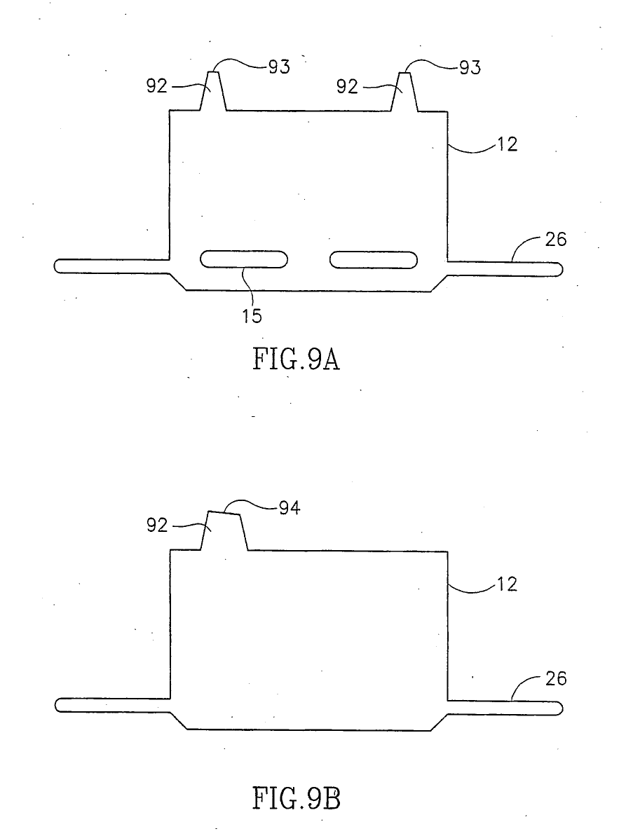

FIG. 9A illustrates a structure for panel 12 that obviates the need for nub 28. As described in the applications listed in the related applications section, the nub is present to reduce the amount of stiction in the CLOSED position. Were the edge of the panel allowed to touch the substrate, the contact area would be so high that it would require an excessive voltage to raise the panel. Using a small nub 28 reduces the stiction. However, while for the reflection panels of these publications, the nub was not a problem, in the present embodiment, the nub sits in an area that should be clear to provide maximum open area. Furthermore, for optimal operation, the nubs should be grounded, which requires a (possibly opaque) line to the nub from the hinge/socket.

In the structure of FIG. 9A, two appendages 92 are provided at the end of panel 12. These appendages have a small tip 93, such that contact between the panel and the substrate is minimized. This reduces stiction and obviates the need for nub 28, while providing a greater open area.

FIG. 9B illustrates a variation of the embodiment of FIG. 9A, with a single appendage 92 with a slanted edge 94 for ease of detachment. This may result in lower stiction, since, the detachment from the substrate is by a peeling action.

Since for both FIGS. 9A and 9B panel 12, at the CLOSED position, is lower than when it rests on nub 28, the levitation electrode may be produced in poly 1 rather than in poly 2. This has the advantage of more accurate positioning of the electrode with respect to the panel. An additional poly 2 levitation electrode may be fabricated above the poly 1 levitation electrode, to increase the effect of the electrode.

FIG. 10 shows a layout of address and locking lines, in accordance with an embodiment of the invention. For clarity, the sockets 21 are not shown and panel 12 is shown for reference.

One of the metal layers (either M1 or M2) comprises row lines (as shown) and the other comprises column lines. The choice of which metal layer provides column or rows is optional. As shown in FIG. 10, the pixels are optionally configured so that the panels associated with adjacent columns open in opposite directions. This reduces the number of lines needed, since a single line can be used for all closer electrodes in two columns. The same line electrifies clutch electrodes 103. In the embodiment shown, opening electrodes 102 in each column are fed by a common column line 1002. (For simplicity of presentation, opening electrode is shown as a single electrode, rather than being split as in FIG. 1.) Closing electrodes 101 and clutch electrodes 103, in adjacent columns are fed from a common line 1004 since they are adjacent, for the configuration shown. All column locking electrodes 106 in each column are fed by a common line 1008; all row locking electrodes 105 in each row are fed by a common line 1006.

Referring again to FIG. 5, the voltages shown in the opening cycle of the upper four graphs are applied to the respective electrodes in each opening cycle, as shown. If one of the locking electrodes (either or both of row and column) is electrified, the particular pixel will not open. Thus the pixels are scanned by scanning the row and selecting column electrodes to select pixels that are to be opened in a particular cycle.

In practice, according to an embodiment of the invention, a frame time is divided into a multiplicity of cycle times, equal to the number of brightness levels to be displayed. For each cycle the proportion of the time that the respective pixels are to be open is determined from the number of brightness levels to be displayed. At the start of the frame, all of the pixels are in the CLOSED position. Then during the first cycle all of the pixels having the highest brightness level are opened. These remain open for the entire frame. In the next cycle, the pixels having one brightness level lower are opened. These also remain open for the rest of the finale. This process continues until all of the brightness levels have been scanned. At the end of the frame, a single CLOSE cycle is performed. This method allows for a large number of brightness levels without excessive energy use and without excessive wear on the pixels.

FIG. 11 schematically shows how the sockets 21 (and hence, knifes 30, panels 12 and nubs 28) are grounded and also how levitation electrodes 18 are electrified, in one exemplary embodiment. As shown, levitation lines 1102 and hinge lines 1104 are provided. In essence, all of the sockets 21 in adjacent columns are grounded using a common line 1104 in poly 2 and all of the levitation electrodes 18 in a column are connected together utilizing levitation line 1002 in poly 2. In fact, the levitation electrodes can be formed as a single long bar in poly 2, which serves both to supply levitation voltages and to raise the panels. For simplicity of explanation, the levitation electrodes and the sockets of adjacent pixels have been described above as being separate and being energized or grounded by some means not shown.

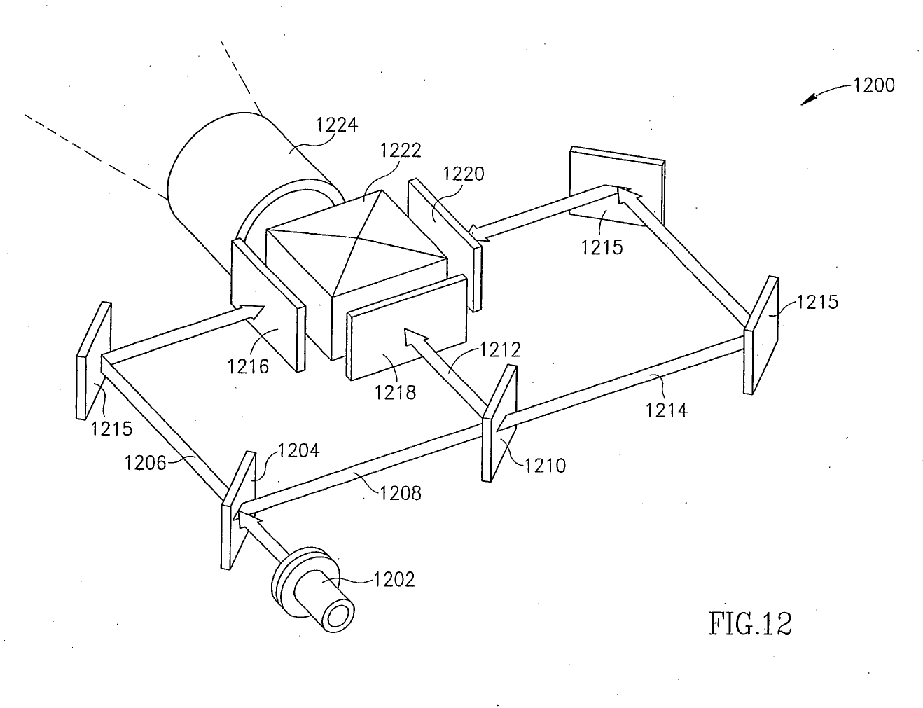

Two main types of transmission type displays are known. In one of these a light source illuminates three separate micro-displays, each with one of red, green and blue light. The modulated light from the three micro-displays is then either combined and projected or projected as overlaid images on a screen. A common light source can be used and split into the three colors or separate light sources can be used for each channel. FIG. 12 shows a projection device 1200 similar to those in the prior art (see, for example, http://www.projector people.com/news_info/lcd-view.asp) except that a shutter array micro-display, as described above is used instead of an LCD for modulating the light.

In display 1200 light from a white light source 1202 impinges on a red dichroic mirror 1204, such that the beam is split into a red beam 1206 and blue and green beam 1208. Beam 1208 impinges on a blue dichroic mirror 1210 such that it is split into a green beam 1212 and a blue beam 1214. Beams 1266, 1212 and 1214 are fed (via mirrors 1215) into three transmission type micro-displays 1216, 1218 and 1220, according to the present invention, in which the light is spatially modulated to form red, green and blue images respectively, that are transmitted through the micro-displays. The light from the micro-displays is combined in a dichroic combiner cube 1222 and projected by a projection lens 1224 onto a screen.

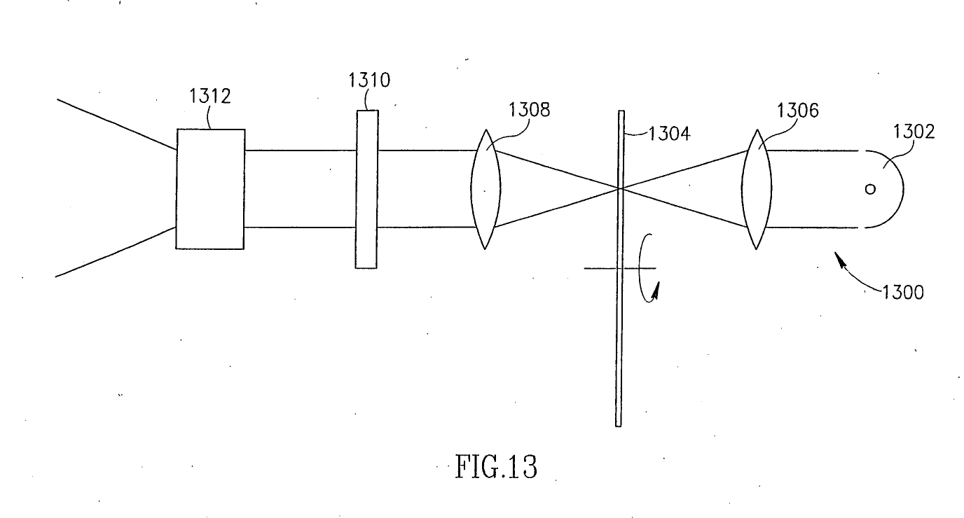

Another type of common projection display is one in which a color wheel is used to change the color of light periodically, so that different color separation images are serially produced. Such devices are also useful with the micro-displays of the present invention. FIG. 13 shows a projection system 1300 in which a light source 1302 is focused onto a color wheel 1304 by a lens system 1306. Focusing of the light source is desirable so that the entire image, at any one time, has the same color. The light from the color wheel is collimated by optics 1308 and impinges on a micro-display 1310 according to the present invention. The light passing through the micro-display is projected by projection optics 1312 onto a screen.

In general, the shutter arrays described herein are compatible with other known image generating schemes or optical switches utilizing LCDs (or other transmission type micro-displays) in which the LCDs can be replaced with the shutter array.

In both FIGS. 12 and 13, drivers for the micro-display, power supplies and, for FIG. 13, a synchronizing system are not shown, but are, of course, present. Both FIGS. 12 and 13 are capable of projecting both still and moving pictures.

It should be understood that the percentage of the area of the array that is transparent can be high, reaching 60, 70, 75 or even 80% of the total area. The drawings, of course, are not to scale, and are drawn for convenience of presentation of the principles of the invention.

Furthermore, due to the small sizes possible using MEMS technology, arrays with many thousands, a million or even several million addressable pixels is possible, resulting in a high resolution display. However, addressing speed may be a concern for large arrays, if many brightness levels are to be displayed. In order to increase the speed, additional address lines may be provided to divide the array into sub-arrays, which are addressed in parallel.

Structures similar to those described above can be used as filters for filtering light that enters an imaging or other receiving system. The constructional variation is that the panels are transparent to a particular band of wavelengths, rather than being opaque. For example, if an array as described above is placed in front of an imaging system and the panels are opaque to visible light and transparent to IR, when the panels are in the OPEN position, all light will pass and a visible light image will be produced by the imager. If all of the panels are in the CLOSED position, the array passes only IR and the image produced by the imager is an IR image. The filter can be very quickly changed from visible to IR and, if desired, a portion of the aperture can pass IR and a portion can pass visible as well. If the entire array is to be switched together, the row and column locking electrodes (and address lines) can be omitted. It is noted that the size of a switchable filter according to the invention is small compared to that of prior art mechanical devices, in addition to being faster.

It will be clear that the present application describes a number of different elements, including, inter alia a rounded (or round) horizontal axle (or other element), a rolling axle, a pixel having a panel that changes position quickly and/or using a low voltage, a method of flipping the panel and a fabrication method. It is understood that while these elements have been described in the context of a display, in order to teach the best mode known to the inventors for carrying out the invention, each of the elements described above is believed to have wider utility in other devices. Furthermore, while the elements have been described in the context where they work together in a single device, it should be clear that many of these novel elements can be utilized, in some embodiments of the invention, without any of (and certainly without all of) the others. For example; the flipping method shown will work with a pixel in which the axles have not been rounded or have been only been partially rounded. The rounded axles can be used with flipping methods described in the prior art and in the references listed in the related applications section.

Furthermore, the elements described above can also be used to produce an RF (or other) switch in which the panel connects between two contacts (RF terminals) on the substrate when in the CLOSED position. This structure provides a very low RF path when the panel is in the OPEN position, since the panel is relatively remote from the contacts in this position.

It will also be clear, the present invention has been described using non-limiting detailed descriptions of exemplary embodiments thereof that are provided by way of example and that are not intended to limit the scope of the invention. Variations of embodiments of the invention, including combinations of features from the various embodiments will occur to persons of the art. For example, rather than providing the pixels on a transparent substrate, they can be provided on an opaque substrate in which apertures have been formed. The scope of the invention is thus limited only by the scope of the claims. Furthermore, to avoid any question regarding the scope of the claims, where the terms “comprise,” “comprising,” “include,” “including” or the like are used in the claims, they mean “including but not necessarily limited to”.

1. Display Apparatus comprising:
light modulating apparatus comprising
a substrate, having a substrate surface, at least a portion of which is transparent or apertured; and
an array of objects each having a maximum dimension smaller than 1 mm attached to the substrate and having an axis about which the object can rotate,
wherein the object has two stable positions, a first stable position at which the object covers a transparent or apertured portion of the substrate and a second stable position at which the transparent portion is at least partially uncovered;
a source of light that illuminates the light modulating apparatus: and
a controller that selectively positions the objects in said first and second positions to form an image in the light passing through the light modulating apparatus,
wherein the positions of the objects are periodically changes to provide a moving image in the light passing through the light modulating apparatus.

2. Apparatus according to claim 1 wherein the substrate is transparent over at least a portion of the area covered by the object in the first stable position and uncovered by the object in the second stable position.

3. Apparatus according to claim 2 wherein the substrate is made of a transparent material.

4. Apparatus according to claim 3 wherein the area of the substrate that is not covered by the object in the first stable position is covered with a substantially opaque material.

5. Apparatus according to claim 3 wherein the substrate is made of an opaque material and at least a portion of the region covered in the first stable position is formed with apertures.

6. Apparatus according to claim 1 wherein the maximum extent of the object is less than 200 micrometers.

7. Apparatus according to claim 6 wherein the maximum extent of the object is under 90 micrometers.

8. Apparatus according to claim 7 wherein the maximum extent of the object is under 50 micrometers.

9. Apparatus according to claim 8 wherein the maximum extent of the object is under 20 micrometers.

10. Apparatus according to claim 9 wherein the maximum extent of the object is 10 micrometers.

11. (canceled)

12. Apparatus according to claim 1 wherein the object comprises a panel, which covers the transparent area in the first stable position.

13. Apparatus according to claim 12 wherein the panel is substantially parallel to the surface of the substrate in the first stable position and is substantially perpendicular to the substrate in the second stable position.

14. Apparatus according to claim 12 wherein the panel is substantially opaque to at least a band of wavelengths.

15. (canceled)

16. Apparatus according to claim 12 and wherein the objects comprise:
an axle, attached to the panel;
an axle support attached to the substrate and having a support surface, wherein:
the axle has a rounded cross-section, as manufactured;
the axle forms a non-zero angle with a perpendicular to the surface; and
the axle is capable of rotation, such that the object rotates about the axis.

17. Apparatus according to claim 16 wherein the axle is along said rotation axis.

18. Apparatus according to claim 16 wherein the axle is at an angle to the axis.

19-23. (canceled)

24. Apparatus according to claim 16 wherein the object extends on both sides of the axle.

25. Apparatus according to claim 16 wherein the axle support surface is generally parallel to the substrate surface.

26. Apparatus according to claim 16 wherein the axis of the axle is substantially parallel to the substrate surface.

27. Apparatus according to claim 26 wherein the panel has a planar surface that is parallel to the axle.

28. Apparatus according to claim 27, wherein the planar object extends to a first extent on one side of the axis and extends to a lesser extent on a second side.

29. Apparatus according to claim 28 wherein the planar object is electrically conducting over at least a portion of its extent.

30. Apparatus according to claim 29 wherein the planar object is conducting over at least a portion of the lesser extent.

31. Display Apparatus comprising:
light modulating apparatus comprising
a substrate, at least portions of which are transparent to a band of wavelengths or are apertured;
an array of panel shaped objects attached to the substrate and rotatable from a first position in which a transparent or apertured portion of the substrate is covered to a second position in which said transparent portion is uncovered;
an axle attached to the panel, which is rotatable, such that the panel rotates about an axis;
a constraint that limits the extent of the rotation to substantially 90 degrees;
a source of light that illuminates the light modulating apparatus; and
a controller that selectively positions the objects in said first and second positions to form an image in the light passing through the light modulating apparatus,
wherein the positions of the objects are periodically changes to provide a moving image in the light passing through the light modulating apparatus.

32. Apparatus according to claim 31 wherein the axis of rotation is an axis of the axle.

33. Apparatus according to claim 32 wherein the panel comprises a first portion on one side of the axle that covers transparent portion of the substrate and a second, tail, portion on the other side of the axis.

34. Apparatus according to claim 33 wherein the constraint comprises an object, protruding from the surface of the substrate, that engages the tail portion when the panel rotates to about 90 degrees.

35. Apparatus according to claim 31 wherein the constraint comprises an object, above the plane of the panel adjacent to the axle, which engages the panel when the panel rotates to about 90 degrees.

36. Apparatus comprising:
a substrate at least portions of which are transparent to a band of wavelengths or are apertured;
an array of panel shaped objects rotatable from a first position in which a transparent or apertured portion of the substrate is covered to a second position in which said transparent portion is uncovered;
an axle attached to the panel, which is rotatable, such that the panel rotates about an axis, wherein the panels comprise a first portion on one side of the axle that covers transparent portion of the substrate and a second, tail, portion on the other side of the axis;
a first, opening, electrode on the substrate underlying a portion of the second portion and the axis;
a second, closing, electrode on the substrate outboard of the second portion when the panel is in the first position; and
a power supply for electrifying the first and second electrodes.

37. Apparatus according to claim 36 wherein the axis of rotation is an axis of the axle.

38. Apparatus according to claim 36 and including a controller that is operative to electrify the opening electrode, when the panel is in the first position, to attract the tail thereto, thereby to flip the tail to said second position.

39. Apparatus according to claim 36 and including a constraint to limit the rotation of the panel to about 90 degrees.

40. Apparatus according to claim 39 wherein the constraint comprises an object that engages the panel when it rotates about 90 degrees.

41. Apparatus according to claim 40 wherein stiction between the object and the panel keeps the panel in said second position.

42. Apparatus according to claim 39 wherein said controller is operative to electrify the closing electrode, when the panel is in the second position, to attract the tail to it, causing the electrode to move from the second position to the first position.

43. Apparatus according to claim 39 and including a levitation electrode, situated above the level of the panel in the first position and wherein the controller selectively electrifies the levitation electrode to aid in at least one of the movements of the panel from the first position to the second position and from the second position to the first position.

44. Apparatus according to claim 39 and including at least one holding electrode situated near the panel in the first position, wherein electrification of at least one holding electrode inhibits movement of the panel from the first to the second positions.

45. Apparatus according to claim 44 wherein the array is a rectangular array of rows and columns of panels, each panel having two holding electrodes, one of the holding electrodes being connected electrically with other such electrodes in the column of the panel and the holding electrodes being connected to other such electrodes in the row of the panel, such that each pixel can be separately allowed to change from the first to the second position by not electrifying both the column and row electrodes associated with the panel.

46. Apparatus according to claim 36 wherein the maximum extent of the panel is less than 1 mm.

47. Apparatus according to claim 36 wherein the maximum extent of the panel is less than 200 micrometers.

48. Apparatus according to claim 36 wherein the maximum extent of the panel is less than 90 micrometers.

49. Apparatus according to claim 36 wherein the maximum extent of the panel is less than 50 micrometers.

50. Apparatus according to a claim 36 wherein the maximum extent of the panel is less than 20 micrometers.

51. Apparatus according to claim 36 wherein the maximum extent of the panel is 10 micrometers.

52. A projection display, comprising:
apparatus according to claim 36;
a source of light that illuminates the apparatus; and
a controller that selectively positions said objects in said first and second positions to form an image in the light passing through the apparatus.

53. A display according to claim 52 wherein the controller is operative to control a brightness of said light passing through a pixel corresponding to a given object by positioning said object in said second position for a time commensurate to said brightness.

54. A display according to claim 53 wherein, for a given frame, the controller is position the objects in the second position at different times during a picture frame and to position all of the objects in the first position at the same time.

55. A multicolor display comprising:
a plurality of displays according to claim 52, each illuminated by a separate light source of a different color; and
a combiner that combines the light passing through the arrays.

56. A display according to claim 52 and including means for periodically changing the color of the light from the light source so that the apparatus is successively illuminated by light of different colors.

57. A display according to claim 56 wherein the means for periodically changing comprises a color wheel.

58. A display according to claim 56 wherein the positioning of the objects and the means for changing the colors are synchronized.

59. A display according to claim 52 and including a projection lens for projecting light passing through the apparatus onto a surface.

60. A display according to claim 52 wherein the positions of the objects are periodically changed to provide a moving image.

61. Apparatus according to claim 1 and including projection optics that projects the light passing through the light modulating apparatus onto a display surface.

62. Apparatus according to claim 31 and including projection optics that projects the light passing through the light modulating apparatus onto a display surface.

63. A method of displaying multiple levels of brightness in a system divided into pixels, in which for each pixel at least one area of a surface is selectively covered to provide a first brightness level and closed to provide a second brightness level, the method comprising:
dividing a cycle into sub-cycle time periods, in accordance with a number of desired brightness levels;
covering pixels at the start of the cycle;
selectively uncovering pixel areas at a time after the start of the cycle such that the time remaining until the end of the cycle corresponds to a specified brightness level for each pixel; and
covering the pixels at the end of the cycle.

64. A display according claim 63 wherein the pixels are arranged in an array and including providing a cycle time such that a moving image is displayed.

65. A projection display, comprising:
light modulating apparatus comprising:
a substrate, having a substrate surface, at least a portion of which is transparent or apertured; and
an array of objects each having a maximum dimension smaller than 1 mm attached to the substrate and having an axis about which the object can rotate,
wherein the object has two stable positions, a first position at which the object covers a transparent or apertured portion of the substrate and a second position at which the transparent portion is at least partially uncovered;
a source of light that illuminates the light modulating apparatus; and
a controller that selectively positions said objects in said first and second positions to form an image in the light passing through the light modulating apparatus,
projection optics that projects the light passing through the light modulating apparatus onto a display surface.
